(19) United States
(12) Patent Application Publication
(10) Pub. No.: US 2021/0088823 A1
(43) Pub. Date: Mar. 25, 2021

(54) FINGERPRINT RECOGNITION APPARATUS

(71) Applicant: Novatek Microelectronics Corp., Hsinchu (TW)

(72) Inventors: Po-Chi Lin, Hsinchu City (TW); Jung-Chung Lee, Taoyuan City (TW)

(73) Assignee: Novatek Microelectronics Corp., Hsinchu (TW)

(21) Appl. No.: 16/831,819

(22) Filed: Mar. 27, 2020

Related U.S. Application Data
(60) Provisional application No. 62/905,421, filed on Sep. 25, 2019.

(51) Int. Cl. G02F 1/1333; G02F 1/1335

(52) U.S. Cl. CPC G02F 1/13338; G02F 1/133524; G02F 1/133504

(57) ABSTRACT

A fingerprint recognition apparatus with light-emitting sources disposed in medium layers between a display panel and a sensor is introduced. The display panel displays according to a first light signal. The fingerprint recognition apparatus comprises: a sensor sensing the fingerprint according to a second light signal; a first medium layer disposed between the display panel and the sensor including a first light-emitting source to emit the first light signal; and a second medium layer disposed between the first medium layer and the sensor including a second light-emitting source to emit the second light signal.

### CROSS-REFERENCE TO RELATED APPLICATION

This application claims the priority benefit of U.S. provisional application Ser. No. 62/905,421, filed on Sep. 25, 2019. The entirety of each of the above-mentioned patent applications is hereby incorporated by reference herein and made a part of this specification.

### BACKGROUND

### Technical Field

The invention relates to a fingerprint recognition apparatus.

### Description of Related Art

Optical fingerprint recognition under the screen is widely used recently. In order for non-self-luminous panels (such as liquid crystal display, LCD) to use fingerprint recognition functions, an infrared (IR) light-emitting source used for emitting IR light to the fingerprint and a sensor used for sensing the IR light reflected from the fingerprint are usually disposed under the LCD panel. In a case that the IR light-emitting source and the sensor are disposed in the same layer, the IR light may not uniformly emit to the fingerprint due to a limited number of the IR light-emitting source. Also, the lightness of the IR light emitted to the fingerprint may decrease due to medium layers between the IR light-emitting source and the fingerprint. The non-uniformity and insufficient lightness of the IR light emitted to the fingerprint may decrease the recognition rate of the fingerprint.

Nothing herein should be construed as an admission of knowledge in the prior art of any portion of the present disclosure.

### SUMMARY

A fingerprint recognition apparatus with light-emitting sources disposed in medium layers between a display panel and a sensor is introduced to improve uniformity and lightness of light of the light-emitting sources emitted to a fingerprint on the display panel and enhance the recognition rate of the fingerprint.

In an embodiment of the disclosure, the fingerprint recognition apparatus includes a display panel displaying according to a first light signal and obtaining a fingerprint; a sensor sensing the fingerprint according to a second light signal; a first medium layer disposed between the display panel and the sensor, including a first light-emitting source to emit the first light signal; and a second medium layer disposed between the first medium layer and the sensor, including a second light-emitting source to emit the second light signal. In an embodiment of the disclosure, the fingerprint recognition apparatus includes a display panel displaying according to a first light signal and obtaining a fingerprint; a sensor sensing the fingerprint according to a second light signal; a third diffuser layer, disposed between the display panel and the sensor, and diffusing the first light signal; a third reflector layer, disposed between the third diffuser layer and the sensor, and reflecting the first light signal; and a third light guide plate layer, disposed between the third diffuser layer and the third reflector layer, comprising a first light-emitting source to emit the first light signal, a second light-emitting source to emit the second light signal, a first reflecting element and a second reflecting element, and guiding the first light signal and the second light signal; wherein the first reflecting element reflects the first light signal and the second reflecting element reflects the second light signal.

To sum up, in the fingerprint recognition apparatus provided by the disclosure, the uniformity and lightness of the light of the light-emitting sources emitted to the fingerprint on the display panel are improved by disposing the light-emitting sources in the medium layers between the display panel and the sensor and the recognition rate of the fingerprint is enhanced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a structure diagram of a fingerprint recognition apparatus according to an embodiment of the disclosure.

FIG. 1B is a light path of sensing the fingerprint of the structure diagram of the fingerprint recognition apparatus in FIG. 1A.

FIG. 1C is a side view and a top view of a medium layer of the structure diagram of the fingerprint recognition apparatus in FIG. 1A.

FIG. 2 is a structure diagram of the fingerprint recognition apparatus according to another embodiment of the disclosure.

FIG. 3 is a structure diagram of the fingerprint recognition apparatus according to another embodiment of the disclosure.

FIG. 4 is a structure diagram of the fingerprint recognition apparatus according to another embodiment of the disclosure.

FIG. 5 is a structure diagram of the fingerprint recognition apparatus according to another embodiment of the disclosure.

### DESCRIPTION OF THE EMBODIMENTS

Embodiments of the disclosure are described hereinafter with reference to the drawings.

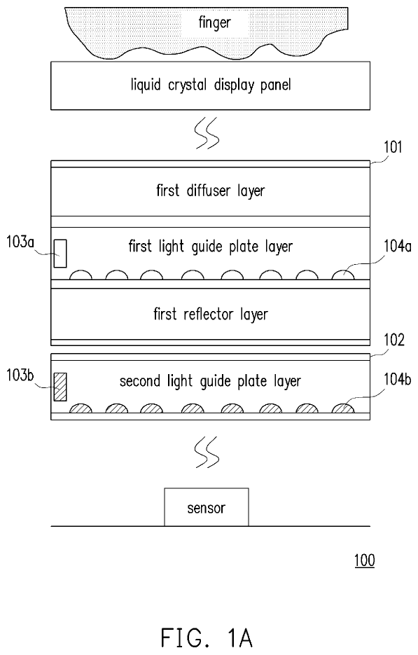

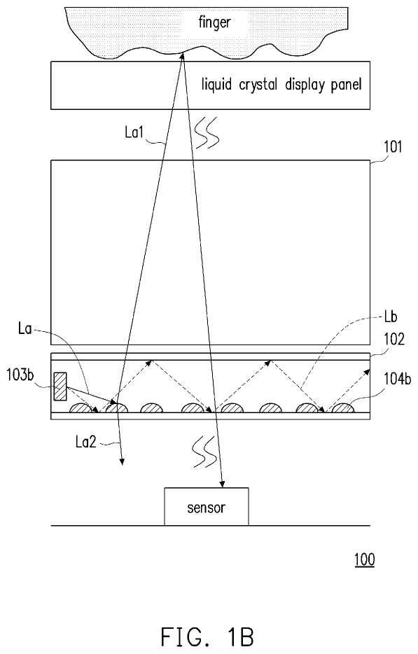

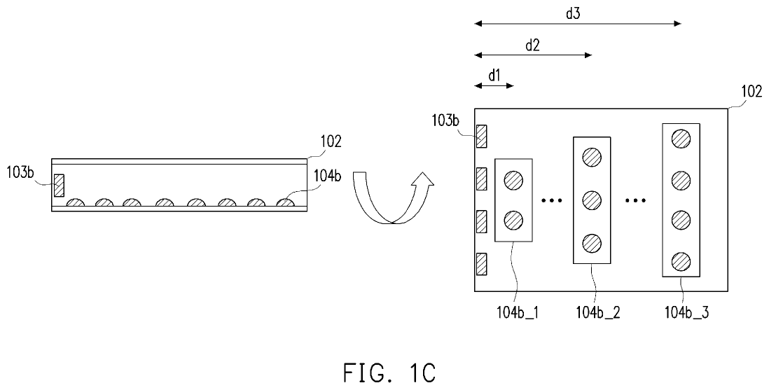

FIG. 1A is a structure diagram of a fingerprint recognition apparatus 100 according to an embodiment of the disclosure. The fingerprint recognition apparatus 100 includes a liquid crystal display panel, a first medium layer 101 similar to a conventional backlight module as an example, a second medium layer 102 and a sensor. The first medium layer 101 includes a first diffuser layer, a first light guide plate layer and a first reflector layer. The second medium layer 102 includes a second light guide plate layer. The first light guide plate layer includes a first light-emitting source 103a (for example: white LED) and a first reflecting element 104a. The second light guide plate layer includes a second light-emitting source 103b (for example: infrared LED) and a second reflecting element 104b.

As shown in FIG. 1A, the liquid crystal display (LCD) panel displays according to a first light signal and obtains a fingerprint. The first light-emitting source 103a disposed in the first light guide plate layer emits the first light signal. The first light guide plate layer guides the first light signal. The first light guide plate layer is disposed between the first diffuser layer and the first reflector layer. The first reflecting element 104a reflects a first part of the first light signal to the first diffuser layer and reflects a second part of the first light signal to the first reflector layer. The first diffuser layer diffuses the first part of the first light signal and the first reflector layer reflects the second part of the first light signal.

As shown in FIG. 1A, the first medium layer 101 is disposed between the LCD panel and the sensor and the second medium layer 102 is disposed between the first medium layer 101 and the sensor.

FIG. 1B is a light path of sensing the fingerprint of the structure diagram of the fingerprint recognition apparatus 100 in FIG. 1A. As shown in FIG. 1A and FIG. 1B, the sensor senses the fingerprint according to a second light signal. The second light-emitting source 103b disposed in the second light guide plate layer emits the second light signal (La, Lb) and the second light guide plate layer guides the second light signal (La, Lb). The second reflecting element 104b reflects a first part of the second light signal La1 to the fingerprint on the LCD panel. The fingerprint on the LCD panel reflects the first part of the second light signal La1 to the sensor. A first wavelength of the first light signal is substantially equal to or different from a second wavelength of the second light signal.

FIG. 1C is a side view and a top view of a medium layer of the structure diagram of the fingerprint recognition apparatus 100 in FIG. 1A. The second reflecting element 104b may be disposed to guide the second light signal in a desired light path. For example, a number of a first part of the second reflecting element 104b_1 disposed in the second light guide plate layer is according to a distance d1 between the first part of the second reflecting element 104b_1 and the second light-emitting source 103b. For example, to uniformly reflects the second light signal to the fingerprint on the LCD panel, the number of the first part of the second reflecting element 104b_1 is less than a number of a second part of the second reflecting element 104b_2 since the distance d1 between the first part of the second reflecting element 104b_1 and the second light-emitting source 103b is less than a distance d2 between the second part of the second reflecting element 104b_2 and the second light-emitting source 103b.

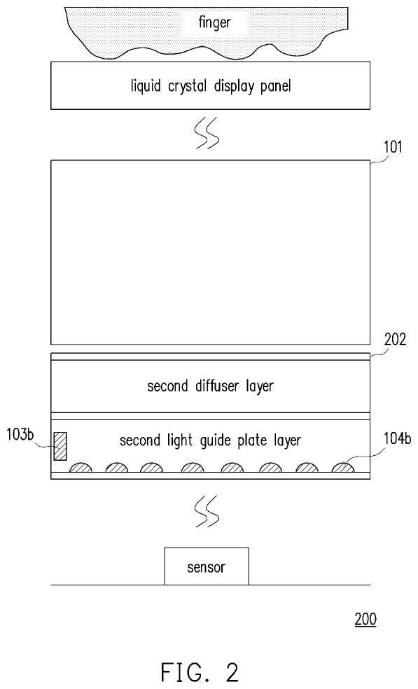

FIG. 2 is a structure diagram of the fingerprint recognition apparatus 200 according to another embodiment of the disclosure. Comparing to FIG. 1A, the second medium layer 202 in FIG. 2 further includes a second diffuser layer. The second diffuser layer is disposed between the first medium layer 101 and the second light guide plate layer. As shown in FIG. 1B and FIG. 2, the first part of the second light signal La1 shown in FIG. 1B is diffused by the second diffuser layer shown in FIG. 2 before reaching the fingerprint on the LCD panel, and therefore the uniformity of the second light signal of the second light-emitting source 103b emitted to the fingerprint on the LCD panel is improved.

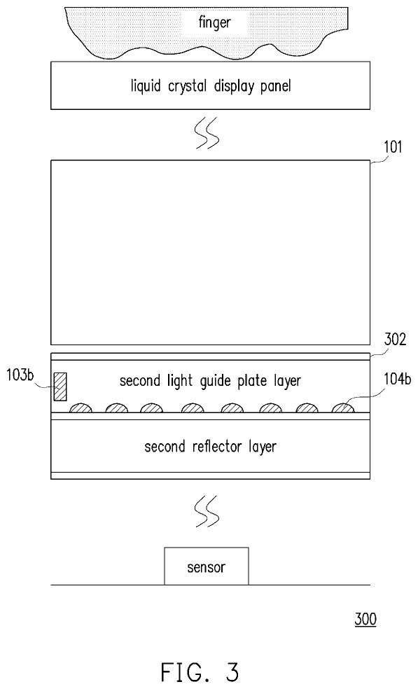

FIG. 3 is a structure diagram of the fingerprint recognition apparatus 300 according to another embodiment of the disclosure. Comparing to FIG. 1A, the second medium layer 302 in FIG. 3 further includes a second reflector layer. The second reflector layer is disposed between the second light guide plate layer and the sensor. As shown in FIG. 1B and FIG. 3, a second part of the second light signal La2 shown in FIG. 1B is reflected by the second reflector layer shown in FIG. 3, and therefore the lightness of the second light signal of the second light-emitting source 103b emitted to the fingerprint on the LCD panel is improved.

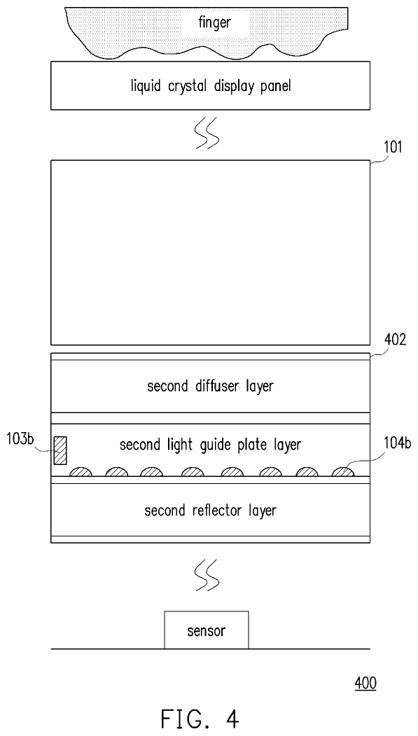

FIG. 4 is a structure diagram of the fingerprint recognition apparatus 400 according to another embodiment of the disclosure. Comparing to FIG. 1A, the second medium layer 402 in FIG. 4 further includes the second reflector layer and the second diffuser layer. The second reflector layer is disposed between the second light guide plate layer and the sensor, and the second diffuser layer is disposed between the first medium layer 101 and the second light guide plate layer. As shown in FIG. 1B and FIG. 4, the second part of the second light signal La2 shown in FIG. 1B is reflected by the second reflector layer shown in FIG. 4, and the first part of the second light signal La1 shown in FIG. 1B is diffused by the second diffuser layer shown in FIG. 4 before reaching the fingerprint on the LCD panel, and therefore the lightness and uniformity of the second light signal of the second light-emitting source 103b emitted to the fingerprint on the LCD panel are improved. In some embodiments of the disclosure, the second medium layer 102, 202, 302, 402 in FIG. 1A, FIG. 2, FIG. 3, FIG. 4 respectively may have a hole area where the second light signal reflected from the fingerprint to the sensor may penetrate without passing the second medium layer 102, 202, 302, 402.

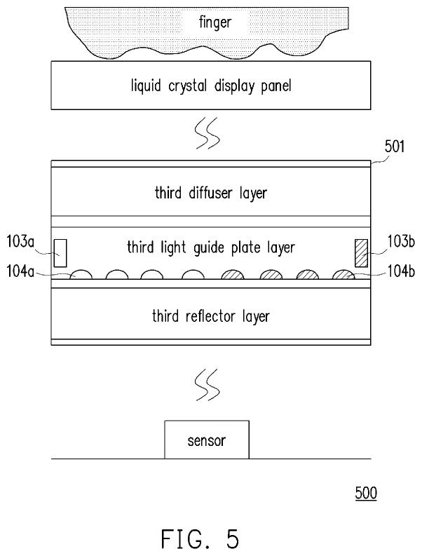

FIG. 5 is a structure diagram of the fingerprint recognition apparatus 500 according to another embodiment of the disclosure. The fingerprint recognition apparatus 500 include the LCD panel, a third medium layer 501 and the sensor. The third medium layer 501 is disposed between the LCD panel and the sensor. The third medium layer 501 includes a third diffuser layer, a third light guide plate layer and a third reflector layer. The third diffuser layer is disposed between the LCD panel and the sensor. The third reflector layer is disposed between the third diffuser layer and the sensor. The third light guide plate layer is disposed between the third diffuser layer and the third reflector layer. The third light guide plate layer may include the first light-emitting source 103a, the second light-emitting source 103b, the first reflecting element 104a and the second reflecting element 104b. The third light guide plate layer may include the first light-emitting source 103a, the second light-emitting source 103b, and a third reflecting element which combines the first light-emitting source 103a and the second light-emitting source 103b. The third diffuser layer includes the first diffuser layer or includes the first diffuser layer and the second diffuser layer shown in FIG. 1A and FIG. 2. The third reflector layer includes the first reflector layer or includes the first reflector layer and the second reflector layer shown in FIG. 1A and FIG. 3. The third diffuser layer diffuses the first light signal or diffuses the first light signal and the second light signal. The third reflector layer reflects the first light signal or reflects the first light signal and the second light signal. A first wavelength of the first light signal shown is substantially equal to or different from a second wavelength of the second light signal. A number of a first part of the second reflecting element 104b disposed in the third light guide plate layer is according to a distance between the first part of the second reflecting element 104b and the second light-emitting source 103b.

To sum up, in the fingerprint recognition apparatus provided by the disclosure, the uniformity and lightness of the light of the light-emitting sources emitted to the fingerprint on the display panel are improved by disposing the light-emitting sources in the medium layers between the display panel and the sensor and the recognition rate of the fingerprint is enhanced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A fingerprint recognition apparatus for integrating into a display panel displaying according to a first light signal, comprising:
a sensor, sensing a fingerprint according to a second light signal;
a first medium layer, disposed between the display panel and the sensor, comprising a first light-emitting source to emit the first light signal; and
a second medium layer, disposed between the first medium layer and the sensor, comprising a second light-emitting source to emit the second light signal,
wherein the first medium layer comprises:
a first diffuser layer, diffusing the first light signal;
a first reflector layer, reflecting the first light signal;
a first light guide plate layer, disposed between the first diffuser layer and the first reflector layer, comprising the first light-emitting source and a first reflecting element, and guiding the first light signal; and
the second medium layer comprises:
a second light guide plate layer, comprising the second light-emitting source and a second reflecting element, and guiding the second light signal, wherein the first reflecting element reflects the first light signal and the second reflecting element reflects the second light signal.

2. (canceled)

3. The fingerprint recognition apparatus as claimed in claim 1, wherein
the second medium layer further comprises:
a second diffuser layer, disposed between the first medium layer and the second light guide plate layer, diffusing the second light signal.

4. The fingerprint recognition apparatus as claimed in claim 1, wherein
the second medium layer further comprises:
a second reflector layer, disposed between the sensor and the second light guide plate layer, reflecting the second light signal.

5. The fingerprint recognition apparatus as claimed in claim 1, wherein
the second medium layer further comprises:
a second diffuser layer, disposed between the first medium layer and the second light guide plate layer, diffusing the second light signal; and
a second reflector layer, disposed between the sensor and the second light guide plate layer, reflecting the second light signal.

6. The fingerprint recognition apparatus as claimed in claim 1, wherein a first wavelength of the first light signal is different from a second wavelength of the second light signal.

7. The fingerprint recognition apparatus as claimed in claim 1, wherein a first part of the second reflecting element disposed in the second light guide plate layer is according to a distance between the first part of the second reflecting element and the second light-emitting source.

8. The fingerprint recognition apparatus as claimed in claim 1, wherein the second medium layer has a hole area where the second light signal reflected from the fingerprint to the sensor penetrates without passing the second medium layer.

9. A fingerprint recognition apparatus for integrating into a display panel displaying according to a first light signal, comprising:
a sensor, sensing a fingerprint according to a second light signal;
a third diffuser layer, disposed between the display panel and the sensor, and diffusing the first light signal;
a third reflector layer, disposed between the third diffuser layer and the sensor, and reflecting the first light signal; and
a third light guide plate layer, disposed between the third diffuser layer and the third reflector layer, comprising a first light-emitting source to emit the first light signal, a second light-emitting source to emit the second light signal, a first reflecting element and a second reflecting element, and guiding the first light signal and the second light signal; wherein the first reflecting element reflects the first light signal and the second reflecting element reflects the second light signal.

10. The fingerprint recognition apparatus as claimed in claim 9, wherein the third diffuser layer further diffuses the second light signal.

11. The fingerprint recognition apparatus as claimed in claim 9, wherein the third reflector layer further reflects the second light signal.

12. The fingerprint recognition apparatus as claimed in claim 9, wherein the third diffuser layer further diffuses the second light signal and the third reflector layer further reflects the second light signal.

13. The fingerprint recognition apparatus as claimed in claim 9, wherein a first part of the second reflecting element disposed in the third light guide plate layer is according to a distance between the first part of the second reflecting element and the second light-emitting source.
